(19) United States
(12) Patent Application Publication
(10) Pub. No.: US 2002/0142872 A1
(43) Pub. Date: Oct. 3, 2002

(54) Blade tensioner

(75) Inventor: Naosumi Tada, Nabari City (JP)

Correspondence Address: BORGWARNER INC., Patent Department, 3001 West Big Beaver Road, Suite 200, P. O. Box 5060, Troy, MI, 48007-5060, US

(73) Assignee: Borg-Warner Automotive K.K.

(21) Appl. No.: 09/880,174

(22) Filed: Jun. 13, 2001

(30) Foreign Application Priority Data
Jun. 14, 2000 (JP) 2000-178293

(51) Int. Cl. F16H 7/08; F16H 7/18

(52) U.S. Cl. 474/111; 474/140

(57) ABSTRACT

A blade tensioner is configured with a blade shoe provided with a chain sliding face, several plate-spring-like blade springs stacked on the reverse side of the chain sliding face of the blade shoe in order to apply a spring force to the blade shoe, and friction plates provided respectively between adjoining blade springs to increase the dampening of the blade tensioner.

### FIELD OF THE INVENTION

The present invention pertains to a blade tensioner, and particularly to a blade tensioner configured with a blade shoe provided with a chain sliding face and several plate-like blade springs for applying spring force to the blade shoe.

### BACKGROUND OF THE INVENTION

A blade tensioner is often utilized as a tensioner for applying tension to a chain. A conventional tensioner may be configured with a blade shoe provided with a chain sliding face and several plate-spring-like blade springs stacked on the reverse side of the chain sliding face of the blade shoe in order to apply spring force to the blade shoe. Respective edge parts of the blade springs are inserted into slots created at the tip part and the base part of the blade shoe.

During the operation of the chain, the chain may run while sliding on the chain sliding face of the blade shoe. At this time, a pressing load can be created as the blade shoe and the blade springs are deformed for acting upon the chain, so that constant tension of the chain is maintained. In addition, chord vibrations caused by thrashing of the chain and/or fluctuation of tension may be propagated to the respective blade springs in the blade shoe via the blade shoe. At this time, when the respective blade springs are repeatedly subjected to elastic deformation and return deformation, a damping force can be created as adjoining blade springs slide against each other, and the chord vibrations of the chain are damped.

In recent applications of a blade tensioner, a large demand has developed for the appearance of a blade tensioner capable of applying even greater damping force to the chain. However, in the case of the aforementioned conventional blade tensioner, the damping force is created only by means of sliding resistance between the stacked blade springs. Thus, the aforementioned conventional structure has limitations in terms of improvement of the damping force.

### SUMMARY OF THE INVENTION

In the present invention, when chord vibrations caused by thrashing of the chain and/or fluctuation of tension act upon the blade shoe, the respective blade springs in the blade shoe may be repeatedly subjected to elastic deformation and return deformation, and great sliding resistance can be created as the blade springs slide against friction parts, so that the damping force of the blade tensioner can be further improved.

Preferably, the friction parts are plate-like members, that is, friction plates, extending in the length direction of the blade springs. In such a case, the friction plates can be either inserted between the respective adjoining blade springs as members independent of the blade springs, or they can be attached to the blade springs as one body by means of bonding or welding (including burn-in).

The friction parts may be configured with several block-like members laid out in the length direction of the blade springs, for example. In such a case, the respective friction parts can be attached to the blade springs by means of bonding or welding (including burn-in).

Furthermore, preferably, bumps may be created on the contact faces between the friction parts and the blade springs. In such case, elastic deformation and return deformation of the friction parts can be achieved more easily. In addition, the friction parts may be configured using rubber, plastic, or friction paper. Although nitrile rubber can be utilized for the rubber, silicone rubber is preferable from the viewpoint of thermal tolerance and abrasion resistance. In addition, nylon 66 is desirable as a plastic material.

The blade tensioner according to an aspect of the invention comprises a blade shoe provided with a chain sliding face, several plate-spring-like blade springs stacked on the reverse side of the chain sliding face of the blade shoe in order to apply a spring force to the blade shoe, and friction parts provided between the respective blade springs provided adjacent to each other.

In a blade tensioner according to another aspect of the invention, the friction parts may be plate-like members extending in the length direction of the blade springs and are provided independently from the blade springs.

In a blade tensioner according to another aspect of the invention, the friction parts may be plate-like members extending in the length direction of the blade springs and attached to the blade springs as one body through bonding or welding.

In a blade tensioner according to another aspect of the invention, the friction parts may be configured with several members extending in the length direction of the blade springs and attached to the blade springs as one body through bonding or welding.

In a blade tensioner according to another aspect of the invention, bumpy surfaces may be created on the contact faces between the aforementioned friction parts and the aforementioned blade springs.

In a blade tensioner according to another aspect of the invention, the aforementioned friction parts may be configured using rubber, plastic, or friction paper.

### BRIEF DESCRIPTION OF THE DRAWINGS

FIG. 1 is a side view of a blade tensioner in accordance with an aspect of the present invention.

FIG. 2 is a side view of blade springs for the blade tensioner of FIG. 1 according to an aspect of the invention.

FIG. 3 is a side view of blade springs for the blade tensioner of FIG. 1 according to an aspect of the invention.

FIG. 4 is a side view of a friction plate to be provided on a blade spring of FIGS. 2 or 3 according to an aspect of the invention.

FIG. 5 is a side view of blade springs for the blade tensioner of FIG. 1 according to an aspect of the invention.

### DETAILED DESCRIPTION

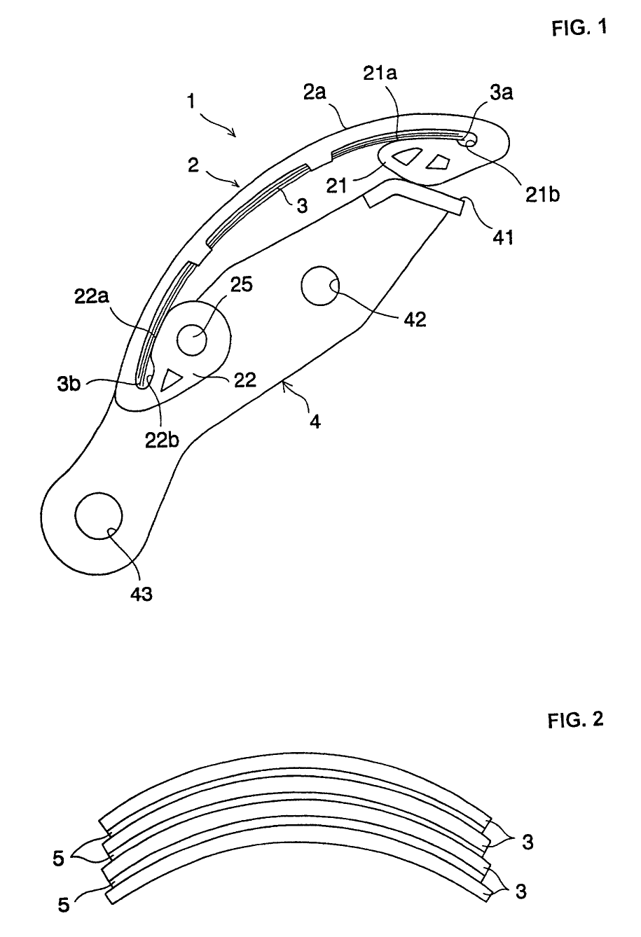

FIG. 1 shows a blade tensioner in accordance with an aspect of the present invention. As shown in FIG. 1, the blade tensioner 1 is configured with a resin blade shoe 2 having an arcuate chain sliding face 2a, several metal blade springs 3 stacked on the reverse side of the chain sliding face 2a of the blade shoe 2 in order to apply a spring force to the blade shoe 2, and a base 4 for supporting the blade shoe 2.

Slots 21a and 22a are created at a tip part 21 and a base part 22 of the blade shoe 2, and respective edge parts 3a and 3b of the blade springs 3 are inserted into the slots 21a and 22a. In addition, concave parts 21b and 22b are created in the respective slots 21a and 22a in order to avoid interference with the edges parts 3a and 3b of the blade springs 3.

Bolt holes 42 and 43 are created on the base 4 in order to insert attachment bolts used to install the blade tensioner 1 into an engine. A sliding face 41 against which the tip part 21 of the blade shoe 2 can slide while remaining in contact with the sliding face 41 is created at the tip of the base 4, and a pin 25 supporting the base part 22 of the blade shoe 2 while allowing it to pivot freely is fixed by one end near the center of base 4.

As shown in FIG. 2, a plate-like friction plate 5 extending in the length direction of the blade spring 3 is provided between the stacked blade springs 3 and 3 to serve as a friction part. In this aspect of the invention, the friction plate 5 is provided as a member independent from the respective adjoining blade springs 3 and 3.

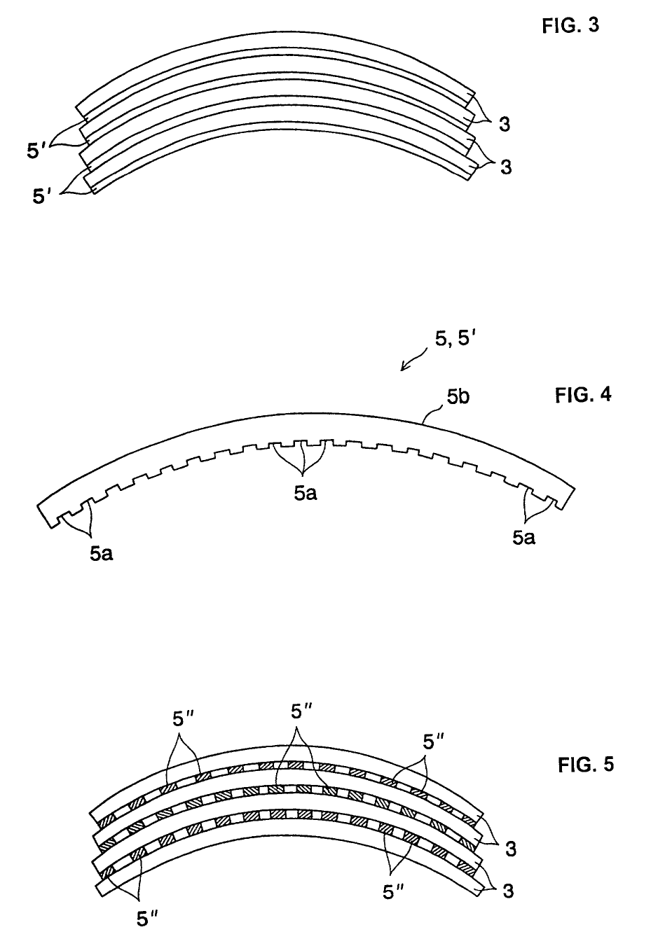

In another aspect of the blade tensioner 1 of the invention, as shown in FIG. 3, a friction plate 5′ may also be provided as one body with the blade spring 3. In such case, the friction plate 5′ is fixed onto the blade spring 3 by means of bonding or welding (including burn-in).

Although nitrile rubber, for example, can be utilized as a material for the friction plates 5 and 5′, silicone rubber is preferable from the viewpoint of thermal tolerance and abrasion resistance. In addition, when plastic which is also acceptable is used, nylon 66 is desirable. Alternatively, friction paper utilized commonly as a facing material may also be utilized.

Furthermore, it is desirable if a bumpy surface with many recesses 5a is created on the reverse side of a blade spring fixing face 5b of the friction plates 5 and 5′, as shown in FIG. 4.

Also, as shown in FIG. 5, the friction part may be configured with several block-like members laid out in the length direction of the blade spring 3 at certain intervals, for example. In such case, respective friction blocks 5″ (parts indicated by slanted lines) are attached onto the blade spring 3 by means of bonding or welding (including burn-in).

With a blade tensioner with these configurations, when chord vibrations caused by thrashing of the chain and/or fluctuation of tension act upon the blade shoe 2, the respective blade springs 3 in the blade shoe 2 are repeatedly subjected to elastic deformation and return deformation as the blade shoe 2 deforms. At this time, the respective blade springs 3 slide against the friction plates 5 and 5′ or the friction blocks 5″ and create great sliding resistance. The damping force of the blade tensioner is further improved by this kind of sliding resistance.

And if a bumpy face is created on the friction plates 5 and 5′, elastic deformation and return deformation of the friction plates 5 and 5′ can be achieved more easily.

In addition, when the friction plates 5′ are fixed to the blade springs 3, the blade spring 3 of the bottommost layer can also be provided with a friction plate 5′ (refer to FIG. 3), whereby, the friction plate 5′ of the blade spring 3 of the bottommost layer slides against the base parts of the respective slots 21a and 21b of the blade shoe 2 as the blade shoe 2 is deformed, so that the damping force of the blade tensioner can be further improved.

As has been described in detail above, the blade tensioner pertaining to the present invention offers an effect wherein friction parts are provided between adjoining blade springs, so sliding resistance is created as the blade springs slide against the friction parts and the damping force of the blade tensioner can be further improved.

1. A blade tensioner for applying tension to a chain, the blade tensioner comprising:
a blade shoe having a first face and an opposing second face, the first face having a chain sliding surface on which the chain is slidable;
at least two adjacent blade springs disposed on the second face of the blade shoe for applying a spring force to the blade shoe, the adjacent blade springs having surfaces contacting in sliding engagement; and
a friction surface provided between the contact surfaces of the adjacent blade springs having a coefficient of friction selected to provide sliding resistance therebetween effective to damp vibrations of the tensioner.

2. A blade tensioner in accordance with claim 1, wherein the friction surface comprises a plate-like member extending in the length direction of the blade springs and is provided independently from the blade springs.

3. A blade tensioner in accordance with claim 1, wherein the friction surface comprises a plate-like member extending in the length direction of the blade springs and attached to at least one blade spring through bonding or welding.

4. A blade tensioner in accordance with claim 1, wherein the friction surface comprises a plurality of members extending in the length direction of the blade springs and attached to at least one blade spring through bonding or welding.

5. A blade tensioner in accordance with claim 2, wherein bumpy surfaces are created on contact faces between the friction surface and at least one blade spring.

6. A blade tensioner in accordance with claim 3, wherein bumpy surfaces are created on contact faces between the friction surface and at least one blade spring.

7. A blade tensioner in accordance with claim 1, wherein the friction parts are configured using rubber, plastic, or friction paper.

8. A blade tensioner in accordance with claim 2, wherein the friction parts are configured using rubber, plastic, or friction paper.

9. A blade tensioner in accordance with claim 3, wherein the friction parts are configured using rubber, plastic, or friction paper.

10. A blade tensioner in accordance with claim 4, wherein the friction parts are configured using rubber, plastic, or friction paper.

11. A blade tensioner in accordance with claim 5, wherein the friction parts are configured using rubber, plastic, or friction paper.

12. A set of spring blades for urging a blade shoe against a chain to apply tension to the chain, the set of spring blades comprising:
a first blade spring having an upper and a lower planar surface;
a second blade spring having an upper and a lower planar surface disposed below the first blade spring, the lower planar surface of the first blade spring and the upper planar surface of the second blade spring in sliding engagement; and
a friction surface provided between the lower planar surface of the first blade spring and the upper planar surface of the second blade spring having a coefficient of friction selected to provide sliding resistance therebetween effective to damp vibrations of the tensioner.

13. A set of blade springs according to claim 12 wherein the friction surface is formed on at least one of the blade springs.

14. A set of blade springs according to claim 12 wherein the friction surface comprises a friction plate disposed between the blade springs.

15. A set of blade springs according to claim 14 wherein the friction plate is attached to at least one of the blade springs.

16. A set of blade springs according to claim 12 wherein the friction surface comprises a plurality of transverse members disposed between the blade springs.

17. A set of blade springs according to claim 16 wherein at least one of the plurality of transverse members is attached to at least one of the blade springs.

18. A set of blade springs according to claim 12 wherein the blade shoe comprises a chain sliding face against which the chain is slidable, wherein the blade springs are disposed between slots formed on a face of the blade shoe opposite the chain sliding face.

19. A set of blade springs according to claim 18 wherein a base is provided for pivotably mounting a first end of the blade shoe.

20. A set of blade springs according to claim 19 wherein a second end of the blade shoe is freely slidable upon the base.

21. A method of applying tension to a chain with a blade tensioner, the method comprising:
providing a base having a sliding surface formed thereon;
pivotably attaching a first portion of a blade shoe to the base, the blade shoe having a chain sliding face and an opposing face opposite the chain sliding face, the blade shoe having a second portion slidable upon the base sliding surface;
biasing the blade shoe against the chain with at least two adjacent blade springs disposed on the opposing face of the blade shoe, the adjacent blade springs having contact surfaces in sliding engagement;
damping vibrations of the tensioner with a friction surface provided between the contact surfaces of the adjacent blade springs providing a coefficient of friction therebetween.

22. A method of applying tension to a chain according to claim 21, including forming the friction surface on the contact surface of at least one of the adjacent blade springs.

23. A method of applying tension to a chain according to claim 21, including forming the friction surface on a friction plate disposed between the contact surfaces of the adjacent blade springs.

24. A method of applying tension to a chain according to claim 23, including attaching the friction plate to at least one of the contact surfaces of the adjacent blade springs.

25. A method of applying tension to a chain according to claim 21, wherein the friction surface comprises a plurality of transverse members disposed between the contact surfaces of the adjacent blade springs.

26. A method of applying tension to a chain according to claim 25, wherein at least one of the plurality of transverse members is attached to at least one of the contact surfaces of the adjacent blade springs.
